(19) United States
(12) Patent Application Publication
(10) Pub. No.: US 2004/0196250 A1
(43) Pub. Date: Oct. 7, 2004

(54) System and method for automatic calibration of a display device

(76) Inventors: Rajiv Mehrotra, Rochester, NY (US); Thomas O. Maier, Rochester, NY (US)

Correspondence Address: Thomas H. Close, Patent Legal Staff, Eastman Kodak Company, 343 State Street, Rochester, NY, 14650-2201, US

(21) Appl. No.: 10/408,529

(22) Filed: Apr. 7, 2003

(51) Int. Cl. G09G 3/36; G09G 5/00

(52) U.S. Cl. 345/102

(57) ABSTRACT

A method for evaluating colorimetry of viewing conditions affecting a viewer and calibrating a display device used by the viewer relative to an environment surrounding the display device is based on measuring display colorimetry data and the colorimetry of the viewing conditions and generating display and viewing condition colorimetry data, wherein the viewing conditions include the effect of surround light originating from the environment surrounding the display device and impinging upon the viewer rather than the display device. A color conversion function is calculated from the display colorimetry data and the viewing condition colorimetry data, where the color conversion function is capable of transforming an input video signal into a transformed video signal that shows an improved image based on the colorimetry of the display device and the colorimetry of the viewing conditions. The color conversion function performs color conversion of the input video signal, thereby generating the transformed video signal which is displayed on the display device.

### FIELD OF THE INVENTION

The present invention relates to the calibration of color display devices, and more specifically to the calibration of a color display device under a variety of illumination conditions that affect the rendition of the displayed colors.

### BACKGROUND OF THE INVENTION

A variety of electronic devices are currently used for home entertainment, including, for example, televisions, home theater systems, video games, DVD input and display systems, and VCR-based TV systems. Other devices having at least a secondary usage for home entertainment include computers and phone equipment. A characteristic of such entertainment systems is that almost all utilize digital technology, and almost all can be adapted to centrally connect to a display system, whether a television, a computer and/or a home theater system.

Since much of the content viewed in these systems is high quality motion imagery, usually prepared by professionals, consumer expectations for content image quality are being raised. There is also a certain videophile segment that is demanding even higher quality. These expectations are frequently dashed because a wide variety of contents are displayed on a variety of different devices from a variety of sources under varying illumination conditions. For instance, it is not uncommon for a consumer to receive high end video data (e.g., DVD, TV shows, and so on), graphics and animation (e.g., video games, cartoons, animated contents), live broadcasts (e.g., sports, news, concerts, award shows), still picture and home video, and documents and webpages (e.g., internet contents and presentations). All of these different contents are viewed in home settings that vary from quite dark (though seldom as dark as a commercial theater, for which any of the contents were shot) to quite bright.

Consequently, a host of problems arise when presenting such source materials. For example, the various contents vary in visual and/or color characteristics. The different display device characteristics are often not matched with the visual and/or color characteristics of the available contents. Furthermore, one display device setting is often not optimal for all types of contents. Additionally, the ambient viewing light and viewing position frequently exerts a considerable impact upon the viewing experience. Many of these contents were produced for a specific kind of viewing environment usually not attainable in a home setting. Because of these problems, the usual result is a sub-optimal content image display and a sub-optimal viewing experience.

There have been certain attempts in the prior art to deal with these problems. In U.S. Pat. No. 6,340,976, Oguchi et al. describe a multi-vision system including chromaticity sensors for performing colorimetry of a plurality of display units which make a very large image by displaying parts of the image on each of the individual display units. Their objective is to make the display units in the system match each other. From the colorimetry results obtained from these sensors, a color conversion coefficient calculation unit inside a calibration unit calculates the color conversion coefficient that is characteristic of each display unit, thereby enabling representative colors to be displayed as a target color on all the display units. This system however is focused solely on the color produced by the display units. In U.S. Pat. No. 5,561,459, Stokes et al. describe the generation of a CRT characterization profile that conveys calibration data from a source monitor to a destination monitor such that colors reproduced on the two monitors agree. The profile includes the gamut of the CRT, the white point setting, the black point setting and the gamma. The effects of ambient illumination are subtracted from the profile at the source end and then added back in at the destination. Stokes et al. is trying to make two display devices match whereas the goal in the present invention is not so much to make two devices match, but rather to make each device produce an image that is optimum.

In U.S. Pat. No. 6,459,425, Holub et al. describes a sensor mounted into a cowl surrounding the screen of a CRT and facing the center of the screen such that it permits unattended calibration of the CRT. During an autocalibration cycle, the screen is darkened and the sensor detects ambient illumination. As understood by those of skill in this art, and as stated by Holub et al. in this patent, ambient illumination refers to light that reflects off the faceplate (or screen) of the display and whose sources are in the surrounding environment. Consequently, ambient illumination as referenced in Stokes et al. and Holub et al. only indicates the light striking the faceplate and does not account for other light in the surrounding environment that does not reflect off the faceplate but nonetheless affects the viewing experience, particularly in a home setting.

What is needed is a semi-automatic color calibration system that brings a theatrical experience into the home and is additionally able to optimize display performance for any given content and viewing condition. Such a system should be easily integrated with existing home display systems and provide a consistent color viewing experience, regardless of the content of the signal entering the home display system and the viewing conditions.

### SUMMARY OF THE INVENTION

The present invention is directed to overcoming one or more of the problems set forth above. Briefly summarized, according to one aspect of the present invention, a method for evaluating colorimetry of viewing conditions affecting a viewer and calibrating a display device used by the viewer relative to an environment surrounding the display device comprises the steps of: (a) measuring the colorimetry of predetermined display colors produced by the display device and generating display colorimetry data; (b) measuring the colorimetry of the viewing conditions and generating viewing condition colorimetry data, wherein the viewing conditions include the effect of surround light originating from the environment surrounding the display device and impinging upon the viewer rather than the display device; (c) calculating a color conversion function from the display colorimetry data and the viewing condition colorimetry data, said color conversion function being capable of transforming an input video signal into a transformed video signal that shows an improved image based on the colorimetry of the display device and the colorimetry of the viewing conditions; (d) using the color conversion function to perform color conversion of the input video signal, thereby generating a transformed video signal; and (e) displaying the transformed video signal on the display device.

According to another aspect of the present invention, a system for evaluating colorimetry of viewing conditions affecting a viewer and calibrating a display used by the viewer relative to an environment surrounding the display comprises: (1) a display unit having a screen; (2) a sensing stage for measuring (a) the colorimetry of predetermined display colors produced by the display unit and generating display colorimetry data, and (b) measuring the colorimetry of the viewing conditions and generating viewing condition colorimetry data, wherein the viewing conditions include the effect of surround light originating from the environment surrounding the display unit and impinging upon the viewer rather than the screen of the display unit; and (3) a calibration stage for (a) calculating a color conversion function from the display colorimetry data and the viewing condition colorimetry data, said color conversion function being capable of transforming an input video signal into a transformed video signal that represents an improved image based on the colorimetry of the display unit and the colorimetry of the viewing conditions, and (b) using the color conversion function to perform color conversion of the input video signal, thereby generating a transformed video signal that is displayed on the display unit.

According to yet another aspect of the invention, calibration apparatus for evaluating colorimetry of viewing conditions affecting a viewer and calibrating an input video signal applied to a display used by the viewer relative to an environment surrounding the display comprises: (1) a sensing stage for measuring the colorimetry of the viewing conditions and generating viewing condition colorimetry data, wherein the viewing conditions include the effect of surround light originating from the environment surrounding the display and impinging upon the viewer rather than the display; and (2) a calibration stage for calculating a color conversion function from the viewing condition colorimetry data, said color conversion function being capable of transforming the input video signal into a transformed video signal that represents an improved image based on the colorimetry of the viewing conditions.

The advantage of the invention is that the color conversion function includes the effect of the viewing conditions typical for a home setting, but nonetheless can be obtained with a minimum input from the viewer. Several advantageous embodiments are possible. For instance, the calibration could be done in the factory according to the procedure set forth in this disclosure for, say, five or so typical ambient settings in the home, and then the viewer would simply pick one. In other words, the viewer would not actually be involved in the calibration process. Alternatively, a service person could come into the home every few years or so to recalibrate the display unit according to the procedure set forth in this disclosure. Or, as described in connection with FIG. 1, the viewer would use a “remote unit” to do calibration in the home according to the procedure set forth in this disclosure.

These and other aspects, objects, features and advantages of the present invention will be more clearly understood and appreciated from a review of the following detailed description of the preferred embodiments and appended claims, and by reference to the accompanying drawings.

### BRIEF DESCRIPTION OF THE DRAWINGS

FIG. 1 is a pictorial view of a display system incorporating calibration according to the invention.

FIG. 2 is a flow diagram for an estimation of a mapping function to compensate for an ambient effect on the display unit shown in FIG. 1.

FIG. 3 is a flow diagram for an estimation of a mapping function to compensate for a surround effect on the display unit shown in FIG. 1.

FIG. 4 is a flow diagram for an estimation of display primary colors and a gamma correction function in a dark room.

FIG. 5 is a flow diagram for an estimation of a mapping function to compensate for a white point on the display unit shown in FIG. 1.

FIG. 6 is a flow diagram for an estimation of display primary colors and a gamma correction function in the presence of ambient light.

FIGS. 7A and 7B are flow diagrams for an input signal correction to produce an output signal for a desired display.

### DETAILED DESCRIPTION OF THE INVENTION

Because image processing and display systems employing calibration are well known, the present description will be directed in particular to attributes forming part of, or cooperating more directly with, a method and system in accordance with the present invention. Method and system attributes not specifically shown or described herein may be selected from those known in the art. In the following description, a preferred embodiment of the present invention would ordinarily be implemented at least in part as a software program, although those skilled in the art will readily recognize that the equivalent of such software may also be constructed in hardware. Given the system as described according to the invention in the following materials, software not specifically shown, suggested or described herein that is useful for implementation of the invention is conventional and within the ordinary skill in such arts. If the invention is implemented as a computer program, the program may be stored in conventional computer readable storage medium, which may comprise, for example; magnetic storage media such as a magnetic disk (such as a floppy disk or a hard drive) or magnetic tape; optical storage media such as an optical disc, optical tape, or machine readable bar code; solid state electronic storage devices such as random access memory (RAM), or read only memory (ROM); or any other physical device or medium employed to store a computer program.

It is instructive to note that the present invention utilizes an image which is typically either a two-dimensional array of red, green, and blue pixel values or an array of monochromatic or color values corresponding to light intensities. As used herein, the term image refers to the whole two-dimensional array, or any portion thereof that is to be processed, and further refers to what is sometimes called either a digital image or a video image. Furthermore, the signals and devices involved may be either digital signals and devices or video signals and devices, or any combination thereof. More specifically, the usage of digital image signal and video image signal in the specification and claims should be understood to be interchangeable, that is, the use of the term video is not meant to exclude digital, and vice versa. In addition, the preferred embodiment is described with reference to an image that may be considered as comprising a certain number of image primaries or channels. In the case of the preferred embodiment, the image comprises three primaries, namely, red, green and blue primary colors, although more than three primaries and other sets of primaries may be used.

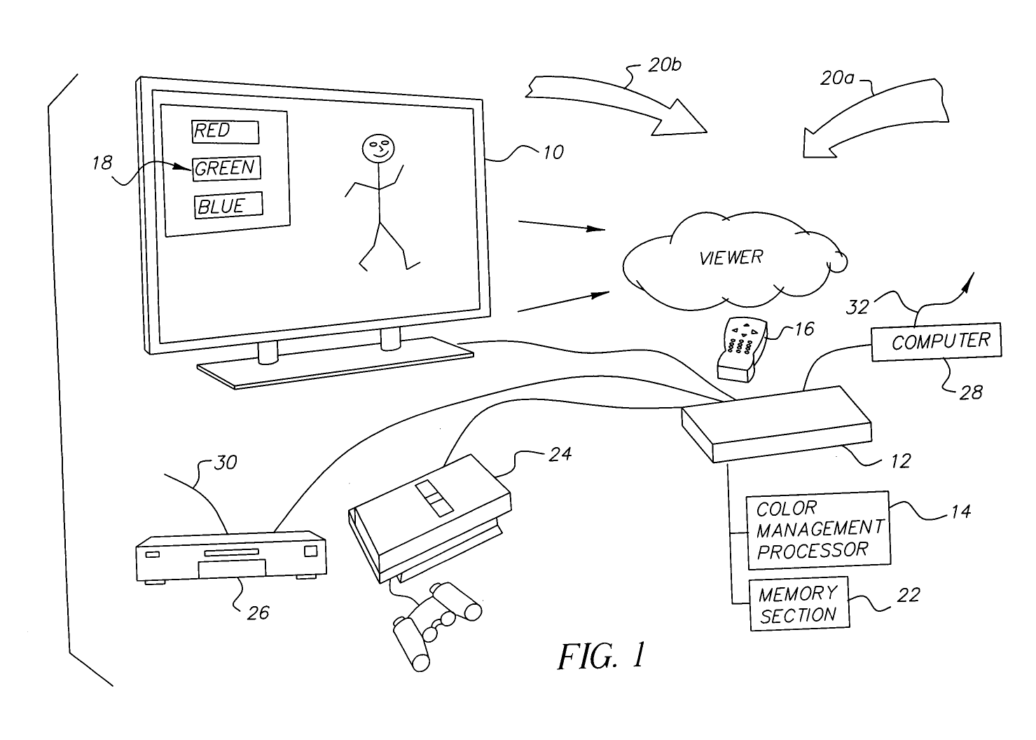

Referring first to FIG. 1, there is shown a pictorial view of the system, and components thereof, of a sensing stage and a calibration stage for providing automatic calibration of a display device according to the invention. More specifically, the system includes a content display unit 10 that receives source material through a calibration stage, such as calibration unit 12. The content display unit 10 may take a variety of forms, including without limitation a television, a home theater display, a computer monitor, a projection or flat screen display, and so on. The calibration unit 12 includes a color management processor 14 that computes the color conversion coefficients and algorithms needed to yield the optimum, or near-optimum, display of the source material on the content display unit 10. The calibration unit 12 also includes, or interfaces with, a sensing stage, herein represented as a sensor unit 16, which is shown in FIG. 1 as a remotely controlled handheld unit although it could be cable-connected or otherwise tethered or docked to or with the calibration unit 12. The function of the sensor unit 16 is to capture the display conditions and the viewing conditions, whether related to one or more specific display colors 18 shown on the content display unit 10 or related to ambient and surround conditions as expressed by ambient light 20a directed toward the content display unit 10 or surround light 20b impinging upon the viewer.

As stated in the background, the ambient light 20a refers to light that reflects off the faceplate (or screen) of the display unit 10 and whose sources are in the surrounding environment. The ambient light 20a reflects from the screen of the display unit 10 and modifies the colors experienced by the viewer. In contrast, although also arising from the surrounding environment, the surround light 20b (generally colored light) reflects or emanates from walls, ceilings, floors, lights, windows, decorative features (mirrors, wall hangings. etc.), furniture, other persons, and the like and impinges upon the viewer rather than upon the faceplate (or screen) of the display unit 10. Although not itself coming off the faceplate (or screen) of the display unit 10, the surround light 20b is seen by the viewer and critically changes the viewer's perception of the totality of the viewing experience. This is important because much of the source material, such as motion pictures transferred to video via a telecine operation, was intended for viewing against an essentially black surround, i.e., in a darkened theater. Thus this viewing condition must be accounted for in order to replicate a theatrical viewing condition.

Certain of the colorimetry functions may be performed by either the sensor unit 16 or the calibration unit 12, depending upon the particular design chosen. In the preferred embodiment, the calibration unit 12 calculates display colorimetry data from the colorimetry of the display colors 18 and viewing condition colorimetry data from the colorimetry of the viewing conditions. From this information the color management processor 14 calculates a color conversion function, which is used to transform an input video signal into a transformed video signal, which is then displayed on the display unit 10. The calibration unit 12 further includes a memory section 22 for storing color conversion functions and calibration data for classes of content, and the processor 14 includes the ability to retrieve, use and modify color conversion functions and calibration settings stored in the memory section 22. The source material is ordinarily a color signal obtained from a variety of input devices, such-as a video game 24, a DVD/VCR player 26, or a computer 28. Other input devices, although not specifically shown in FIG. 1, may include without limitation a camcorder, a digital camera, an image scanner, a set-top box, a laptop computer, various types of networked devices, and so on. In addition, a cable/satellite input connection 30 is provided, and the computer 28 may input images over a network connection 32 connected, e.g., to the Internet or some other type of network provider. And of course, although not specifically shown, the color signal may be directly received off the air by the display unit 10 as a television signal.

General Description of the Home Entertainment Calibration System.

It is helpful in understanding the invention to realize that there are certain requirements for a home entertainment display system that is calibrated and configured according to the invention. These requirements will be addressed in the following sections.

Since the most common display devices in a home entertainment system are additive devices, the following description of the calibration unit 12 will be made in terms of an additive calibration for an additive system. An additive system is commonly defined by three primaries (such a system may have more than three primaries, but three is the most common number). These are most often nominally a red primary, a green primary, and a blue primary. In theory, the position of the primary when plotted on a chromaticity diagram does not change as a function of an intensity of that primary. In practice, however, the position of the primary may change as a function of the intensity, and the display device will not give the assumed color for a given input signal. In addition, there is an assumed relationship between a displayed luminance and an input signal. In analog systems, the input signal is a voltage and in digital systems, the input signal is a code value. The problem is that any specific device may not give the assumed displayed luminance for a given input signal.

Therefore, the objective of the home entertainment calibration unit 12 is to make the home entertainment display device 10 display the color that is represented (i.e., encoded) by the input signal. This involves the steps of 10 measuring the actual colors displayed by a set of predetermined input signals followed by the calculation of an algorithm that will alter the input signal such that the actual device will produce the color that the input signal actually encoded. The easiest algorithm that would do the calibration is a 3×3 matrix to correct for the colors of the primaries (i.e., it is assumed that there are 3 primaries) and three one-dimensional look-up tables (again assuming three primaries) to correct for luminance. (For n>3 primaries, and because only three numbers are needed to describe every color, a 3×n matrix is needed. There are other mathematical equations to describe systems with more than three primaries, but a process similar to what is described here could be used to calibrate these systems.) From published standards for encoding color signals, it is possible to calculate a 3×3 matrix that relates the normalized input signals, herein referred to as RGB signals, and the encoded color as defined by its CIE tristimulus values, herein referred as XYZ values. This 3×3 matrix is dependent on the defined white point, that is, the XYZ values that are obtained when the RGB input values are at their maximum values. The white point is specified in any standard. Therefore, from the standard for encoding colors, the RGB-to-XYZ matrix can be calculated. The inverse of this 3×3 matrix is the XYZ-to-RGB matrix.

Therefore, by measuring the XYZ values of each primary on an actual display device and the XYZ values for the white point, the RGB-to-XYZ matrix for any actual device can be calculated. The inverse of this 3×3 matrix is the XYZ-to-RGB matrix for the actual device.

The calibration for the primaries involves the calculation of the XYZ values of the encoded color for an input RGB signal. Since this is the intended color, multiplication of these XYZ values by the XYZ-to-RGB matrix for the actual device will give the RGB signals that are needed in the actual device to produce the encoded color. Since these are two 3×3 matrices, they can be multiplied so that the algorithm only involves one 3×3 matrix multiplication.

In a similar manner, every standard defines the relationship between the input signal and the expected luminance. Therefore, a plot of the input signal and luminance can be constructed. Consequently, by sending a set of input signals to the display device and measuring the resulting luminance, the relationship between input signal and luminance for the actual display device can be measured.

The calibration of the relationship between the input signal and the luminance makes use of both the standard relationship and the measured relationship. The process is typically called a Jones Diagram analysis. What is desired is a one-dimensional look-up table that relates the input signal and the actual signal. The input signal is mapped through the standard input signal—luminance curve to give the encoded luminance. Then that luminance is mapped through the measured input signal—luminance curve to give the actual input signal needed. The calibration look-up table is the set of standard input signals and the actual input signals that give the same luminance.

From this description, which is a good starting point for the simplest embodiment of the invention, it can be seen that what the home entertainment device calibration unit 12 needs is to send defined input signals to the actual device 10 and measure (with the sensor unit 16) both the relative XYZ values and the absolute luminance of the light emitted by the display device 10. If the chromaticity coordinates of the RGB primaries change as a function of the input signals, the algorithm will need to be refined a bit to account for this change in color as a function of input signal.

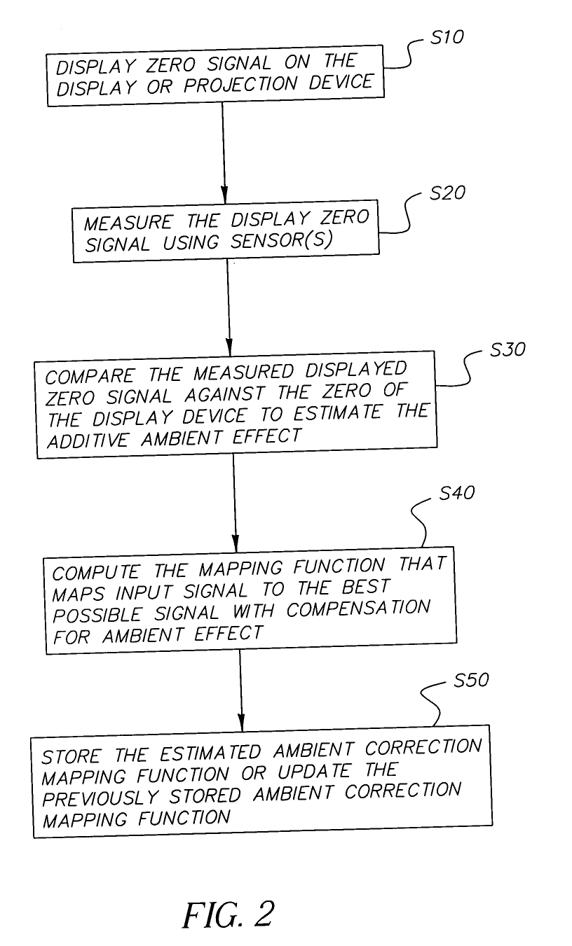

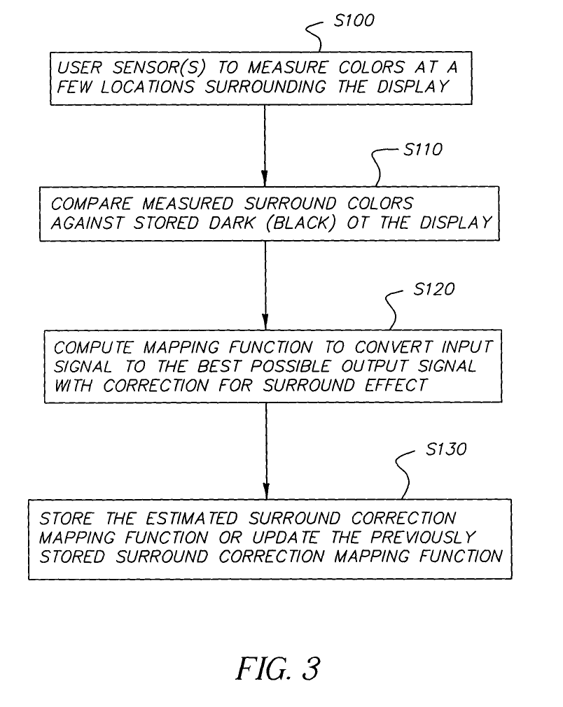

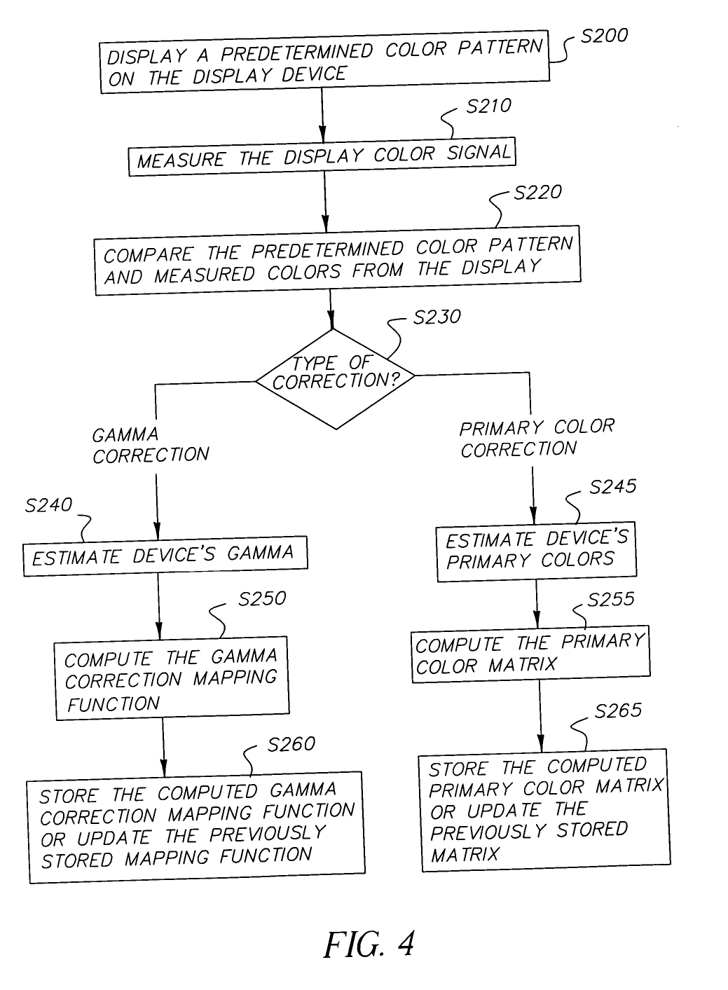

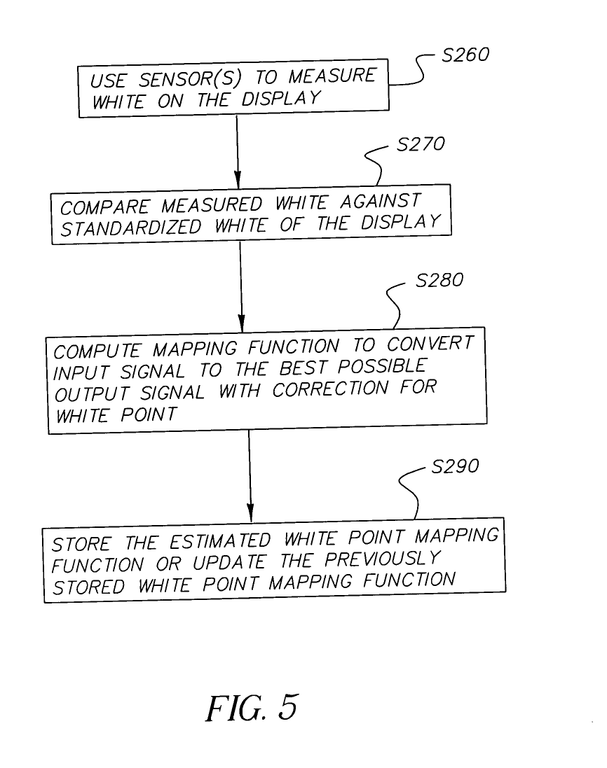

The calibration is performed by a series of steps that the user goes through with the remote sensor unit 16, in each case pointing the sensor unit at features on the screen or in the surrounding environment. These steps are embodied in FIGS. 2-5, which represent the methodology for establishing the color conversion function to convert the incoming RGB signal to the correct signal for reproducing the color that the input signal actually encoded. Much more will be said about these figures, but in brief they interface with the user in the following manner. In each case, the user points the remote sensor unit 16 at a specified feature and actuates (pushes) a button or the like to trigger the sensor unit to capture a light sample of that feature, or to trigger the calibration unit to store the signal value for that feature (if it is part of the incoming video signal). FIG. 2 shows the correction for black due to an ambient effect, where the user points the sensor unit 16 at a blank (black) screen on the content display unit 10. FIG. 3 shows a correction for surround colors, where the user points the sensor 16 around the room in which the content display unit 10 is located. FIG. 4 shows corrections (a gamma correction and a primary color correction) for what the content display unit 10 actually does the input RGB signals, where the user points the sensor unit 16 at a color chart on the screen of the content display unit 10. FIG. 5 shows a correction for white point, where the user points the sensor unit 16 at a white screen (maximum RGB) on the content display unit 10.

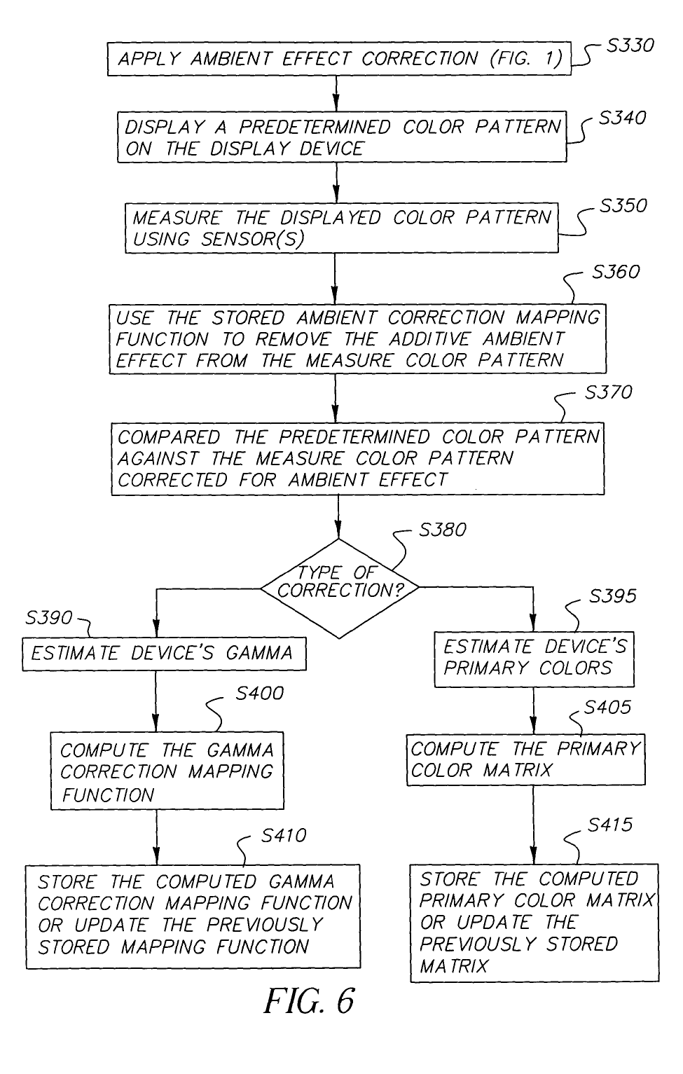

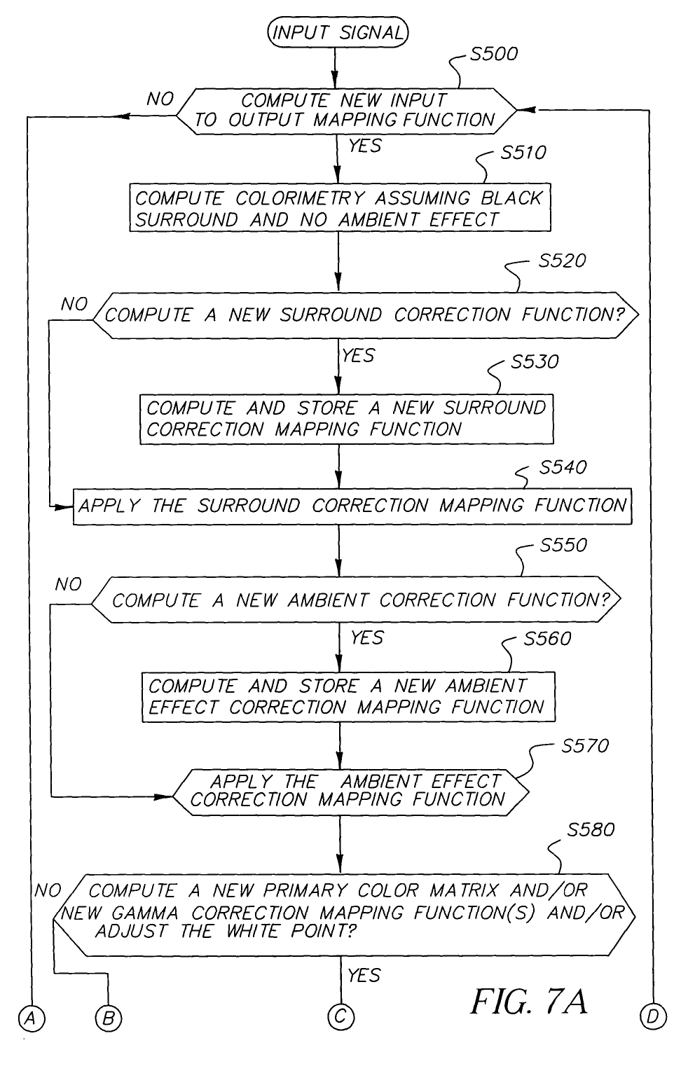

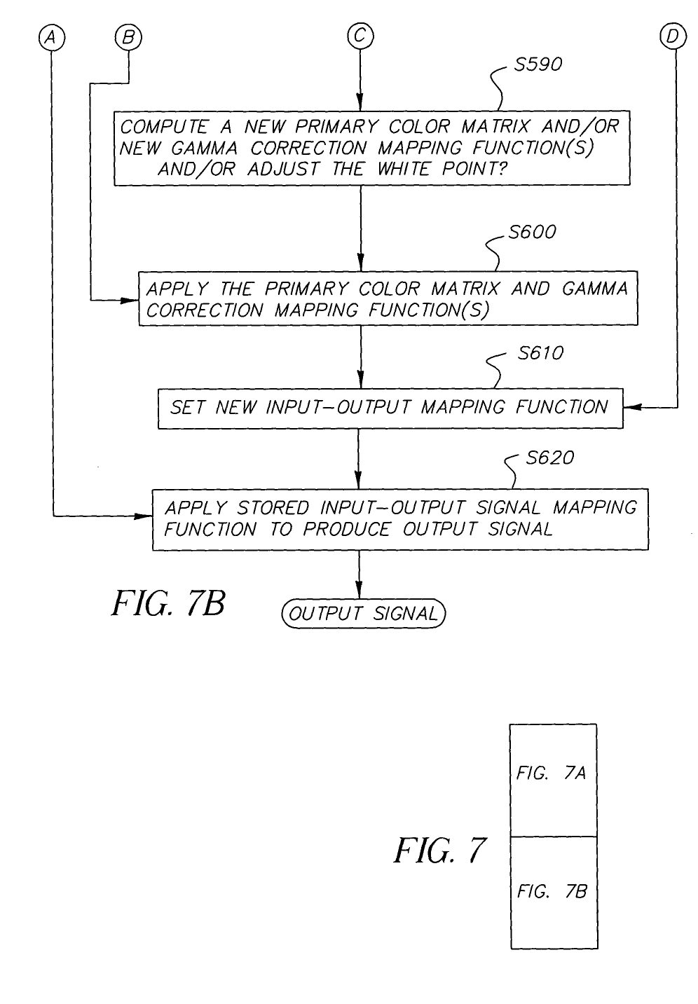

FIG. 6 is a special case where the ambient correction performed in FIG. 2 is applied before the type of estimation shown in FIG. 4. In each of the FIGS. 2-6, a mapping function is determined from estimation procedures as outlined in those figures. FIG. 7 shows how the mapping functions developed in FIGS. 2-5 (and 6) are applied to the input video signal. Each of the flow diagrams in FIGS. 2-7 will now be described in more detail.

Description of the Mapping Functions and Their Use in Correcting an Input Signal for a Proper Display.

The processing path for the data that comes into the calibration device 12 and goes to the display unit 10 is shown in the subsequent paragraphs. We should be mindful that in a television none of these calculations are actually performed because this path only models what physically happens. However, this path is a convenient way to understand the processing that could be done and where changes in that path could be introduced. For instance, the processing for the function to compensate for the ambient effect on the display can be understood from that set of calculations.

Initially, with reference to FIG. 2, the display unit 10 is set in step S10 to a zero signal that corresponds to black. Therefore, the measured light (step S20) off the display represents any ambient light that is falling on the display and is being reflected to the observer. The tristimulus values XYZa that represent this light can be calculated by procedures defined by the CIE in CIE 15.2. Since light is additive and therefore tristimulus values are additive, we can estimate the additive ambient effect (step S30) and compute a mapping function (S40) that makes a change in the signal sent to the display device based on the tristimulus values of the ambient reflected light. The transmitted signals are Y′P′_{B}P′_{R}. From these transmitted signals, we can compute the tristimulus values XYZt that the device is intended to show. The estimated ambient correction function is then stored (step S50) in the memory section 22. Since XYZt represent the intended tristimulus values, we can write an equation relating the tristimulus values from the ambient light and the tristimulus values of the display XYZd without the ambient light, as follows:

XYZt=XYZd+XYZa

By rearranging this equation, we can write

XYZd=XYZt−XYZa

Therefore, XYZd are the tristimulus values that we want the device to produce such that when the device light is added to the ambient light, the resulting light is the intended light from the display. Again, referring to the processing path described below, given XYZd, we can compute a mapping function which will determine the RGB values and finally the Y′P′_{B}P′_{R} signals that must be sent to the device.

Referring to FIG. 3, the sensor unit 16 is used in step S100 to measure colors at a few locations surrounding the display unit 10, i.e., by pointing the sensor unit 16 around the room in which the display unit 10 is located. Then, in step S110 the measured surround colors are compared against stored dark (black) of the display unit 10. In step S120, a mapping function is computed for converting the input signal to the best possible output signal with a correction for the surround effect.

Because there are a variety of TV standards, the mapping function varies with the standard defining the TV signal. This is a sample calculation based on the SMPTE 274M-1995 standard. The signal is Y′P′_{B}P′_{R}. The defining equations are:

Y′=+0.2126 R′+0.7152 G′+0.0722 B′

P′_{B}=(0.5/(1−0.0722))(B′−Y′)=0.5389 B′−0.5389 Y′

P′_{R}=(0.5/(1−0.2126))(R′−Y′)=0.6350 R′−0.6350 Y′

The computation in step S120 involves a number of sub-steps. The first sub-step in S120 is to convert the Y′P′_{B}P′_{R} to R′G′B′. The conversion equations are:

R′=Y′+P′_{R}/0.6350

G′=Y′+0.4681 P′_{R}+0.1873 P′_{B}

B′=Y′+P′_{B}/0.5389

Then it is necessary to convert the R′G′B′ to linear RGB values. The general equations are:

X=X′/4.5

0≦X′≦0.081 (Eq. 1)

X=((X′+0.099)/1.099)⁽1.0/0.45)

0.081≦X′≦1

where X refers to R, G, or B and X′ refers to R′, G′, or B′.

Then it is necessary to convert the RGB values to XYZt, the tristimulus values that correspond with the transmitted Y′P′_{B}P′_{R} values using the phosphor matrix:

Xt=0.412 R+0.358 G+0.180 B

Yt=0.213 R+0.715 G+0.072 B

Zt=0.019 R+0.119 G+0.950 B

Using the measurements taken in step S100, compute the average luminance of the surround and call that Ys. Define the stored white luminance in S110 as Yw. Then define

k=log 10(Yw/Ys)

If k>2.0, then

C=1.0

n=1.0

If 0≦k≦2.0,then

C=1.04−0.02*k (Eq. 2)

n=0.925+0.0375*k

If k<0, then

C=1.04 (Eq. 3)

n=0.925

These values of C and n (C=1.04 and n=0.925) in (Eq. 3) were found to be optimum for motion images. However, improved images that are less than optimum can be produced using somewhat different numbers. For instance, we have found that improved images still may be obtained for 1.02≦C≦1.30 and 0.85≦n≦0.99. If any of these other values are used for C and n, then the values of C and n in (Eq. 2) must be changed, as follows. Define the equation for C in (Eq. 2) as

C=c1−c2*k

where c1 has the value given to C in (Eq. 3) and c2=(c1−1)/2. Then, define the equation for n in (Eq. 2) as

n=n1+n2*k

where n1 has the value given to n in (Eq. 3) and n2=(1−n1)/2.

Now, starting with the XYZt tristimulus values calculated for each pixel of the TV image,

x=(C*Yt)ⁿ/Yt

Xsc=x*Xt

Ysc=x*Yt

Zsc=x*Zt

The Xsc, Ysc, and Zsc are the surround-corrected tristimulus values. Next these have to be converted into RGB values

R=3.248 Xsc−1.543 Ysc−0.499 Zsc

G=−0.973 Xsc+1.879 Ysc+0.042 Zsc

B=0.057 Xsc−0.205 Ysc+1.057 Zsc

Then it is necessary to convert the RGB to non-linear R′G′B′ values. The general equations are:

X′=4.5*X′

0≦X≦0.018

X′=1.099*X^{0.45}−0.099

0.018≦X≦1

where X refers to R, G, or B and X′ refers to R′, G′, or B′.

Finally, it is necessary to calculate the adjusted Y′P′_{B}P′_{R} values.

Y′=0.2126 R′+0.7152 G′+0.0722 B′

P′_{B}=(0.5/(1−0.0722))*(B′−Y′)

P′_{R}=(0.5/(1−0.2126))*(R′−Y′)

Referring now to the estimation of display primary colors and gamma correction function in a dark room as set forth in FIG. 4, in step S200 the predetermined color pattern 18 (see FIG. 1) is displayed on the screen of the content display unit 10 and the displayed colors are measured by the sensor unit 16, i.e., the sensor unit 16 is pointed at each of the predetermined colors 18 in turn and each color is sensed and measured by the unit 16. Then, in step 220, the measured colors from the display unit 10 and the known values for the predetermined color pattern are compared. At this point, there are a number of ways we can go (step 230) depending on the type of measuring device we used in step S210.

Consider the easiest calculations and least expensive type of sensor. If the sensor used in step S210 will only measure luminance, and not color, a gamma mapping function will be computed (steps S240 to S260). Therefore, because we cannot measure the colors of the primaries, we have to assume the primaries are located at the standardized colorimetry. But we will be able to measure the luminance for a series of patches in which R′=G′=B′ (a neutral scale) and the R′, G′, and B′ values cover a range of values. By 35 interpolation we can estimate the luminance associated with all possible values of R′, G′, and B′. Likewise, using the set of equations in (Eq. 1) relating the encoded X′ and linear X where X′ corresponds to R′, G′, or B′ and Y corresponds to the relative luminance, we can calculate a table relating R′, G′, and B′ to luminance. From these two tables, we can find those points where the luminance is the same and relate the actual R′, G′, and B′ values to the standard R′, G′, and B′ values. This defines a one-dimensional look-up-table relating the measured R′, G′, and B′ values to the standardized R′, G′, and B′ values. Then our mapping function for the gamma correction is this one-dimensional look-up-table.

Note that in the above description, we have described how to calculate and use one one-dimensional look-up-table that will be used to modify the R′, G′, and B′ values. However, there are instances in which better results can be achieved if a different one-dimensional look-up-table is used for each of the R′, G′, and B′ values. This is a description of the method to calculate the three one-dimensional look-up-tables using a sensor that can only measure luminance. Again, we have to assume the primaries are located at the standardized colorimetry. But we will be able to measure the luminance for a series of patches in which R′ varies and G′=B′=0. This is a black to red series. By interpolation we can estimate the luminance associated with all possible values of R′. Likewise, using the set of equations in (Eq. 1) relating the encoded X′ and linear X where X′ corresponds to R′, G′, or B′ and Y corresponds to the relative luminance, we can calculate a table relating R′, G′, and B′ to luminance. From these two tables, we can find those points where the luminance is the same and relate the actual R′ values to the standard R′ values. This defines a one-dimensional look-up-table relating the measured R′ values to the standardized R′values. Then our mapping function for the gamma correction of R′ is this one-dimensional look-up-table. In a similar method, we will be able to measure the luminance for a series of patches in which G′ varies and R′=B′=0, this is a black to green series, and a mapping function for the gamma correction of G′ is this one-dimensional look-up-table. In a similar method, we will be able to measure the luminance for a series of patches in which B′ varies and R′=G′=0, this is a black to blue series, and a mapping function for the gamma correction of B′ is this one-dimensional look-up-table.

A more complex solution involves a sensor that can measure in step S210 both the color of the patches and the luminance of the patches; from these measurements a primary color correction is computed (steps S245 to S265). In this case, we can again compute the one-dimensional look-up-table to correct for any errors in the R′, G′, and B′—luminance relationship. But we can also correct for any color errors the primaries have relative to the standardized color of each primary. In order to do this, we need to measure the tristimulus values of patches that have light from only the red primary, from only the green primary, and from only the blue primary. The normal way and the easiest way to make this measurement is to measure the patches in total dark. But we are assuming the user will use this calibration device in a normal setting, not a totally dark room.

Let us first describe the method in a totally dark room. The user measures the tristimulus values of the colors of each primary alone. This is done by making a patch with the red primary on and the green and blue primaries off, then the green primary on and the red and blue primaries off, then the blue primary on and the red and green primaries off. With this information, the transformation matrices from RGB to XYZ and from XYZ to RGB can be computed by the method described in SMPTE Recommended Practice, RP 177-1993. In addition, this SMPTE Recommended Practice describes how to combine matrices so as to transform signals from one set of reference primaries (the transmitted signal primaries) to a set of display primaries (the user's display device that this invention will calibrate).

This transformation involves the steps of converting the transmitted RGB signals into XYZ values and then converting the XYZ values into the device RGB signals. These two steps can be combined into one step using a 3×3 matrix. The total algorithm is very similar to that described for the surround correction above. The transmitted Y′P′_{B}P′_{R} signals are converted to linear RGB signals, the RGB signals are transformed into display RGB signals using the transformation matrix described above, and the display RGB signals are converted into Y′P′_{B}P′_{R} signals as described in the surround correction section above.

In the case in which the room is not totally dark when the measurements of the pure primary color patches are made, there may be a little room light reflected off the display. Because light is additive and therefore XYZ tristimulus values are additive, we need to make the same measurement that was done in the first step in which the user measured the light coming from the display when the signal to the device is black (0 0 0). Let us call these ambient tristimulus values XYZa, then the tristimulus values of the primaries we need are the measured tristimulus values when each primary is on alone minus the XYZa values. In equation form:

XYZr=XYZrm−XYZa

XYZg=XYZgm−XYZa

XYZb=XYZbm−XYZa

where XYZrm, XYZgm, and XYZbm are the measured tristimulus values of the red, green, and blue primaries and XYZr, XYZg, and XYZb are the tristimulus values of the primaries that would be measured in total dark and used in the calculations described above.

Referring now to FIG. 5, which shows a method for estimating a mapping function to compensate for white point on the display, in order to make corrections for the white point of the display, it is necessary to have a measuring device that can measure (in step S260) red, green, and blue signals, not simply a light meter that measures light intensity only. This is similar to the requirements above in order to correct for the primaries of the display. We will need the tristimulus values of the white point of the display, XYZwm, where the wm stands for ‘white as measured’. We will need to normalize the XYZwm to a Y of 1 by dividing XYZwm by Ywm. In these sample calculations, the standardized tristimulus values of the white point, XYZws, where the ws stands for ‘white as standardized’, are (0.9504 1.0000 1.0889). In the equation above that converts the RGB values to the XYZ values, use of (1 1 1) as the RGB values (the white point is defined by the RGB values at their maximum allowed values which is 1), these XYZws tristimulus values will be produced. The phosphor matrix, given above, based on Rec. 709, is

$$M = [ \begin{matrix}0.412 & 0.358 & 0.180 \\ 0.213 & 0.715 & 0.072 \\ 0.019 & 0.119 & 0.950\end{matrix} ]$$

To convert the XYZws to XYZwm, we can use the matrix equation:

$$[ \begin{matrix}Xwm \\ Ywm \\ Zwm\end{matrix} ] = [ \begin{matrix}Xwm / Xws & 0 & 0 \\ 0 & 1 & 0 \\ 0 & 0 & Zwm / Zws\end{matrix} ] * [ \begin{matrix}Xws \\ Yws \\ Zws\end{matrix} ]$$

Since the phosphor matrix converts RGB values into XYZ values, we can write

$$[ \begin{matrix}Xwm \\ Ywm \\ Zwm\end{matrix} ] = [ \begin{matrix}Xwm / Xws & 0 & 0 \\ 0 & 1 & 0 \\ 0 & 0 & Zwm / Zws\end{matrix} ] * M * [ \begin{matrix}R \\ G \\ B\end{matrix} ]$$

Therefore a new phosphor matrix can be defined that combines the phosphor matrix associated with the standard Rec. 709 and these measured white tristimulus values:

$$Mnew = [ \begin{matrix}Xwm / Xws & 0 & 0 \\ 0 & 1 & 0 \\ 0 & 0 & Zwm / Zws\end{matrix} ] * M$$

Thus we can use a new phosphor matrix, Mnew, in our calculations converting RGB to XYZ. We can use the inverse of Mnew to convert XYZ to RGB:

RGB=Mnew⁻¹*XYZ

Therefore the processing path to correct the displayed image for the fact that the display has an incorrect white point is as follows:

The first step is to convert the Y′P′_{B}P′_{R} to R′G′B′.

Then it is necessary to convert the R′G′B′ to linear RGB values.

Then it is necessary to convert the RGB values to XYZt, the tristimulus values that correspond with the transmitted Y′P′_{B}P′_{R} values.

Then it is necessary to convert the XYZt tristimulus values into RGB values using Mnew.

Then it is necessary to convert the RGB to non-linear R′G′B′ values.

Finally, it is necessary to convert the R′G′B′ values into the adjusted Y′P′_{B}P′_{R} values.

The equations for all for all of these transforms have been given above.

Referring now to FIG. 7A, now that each individual correction has been described, we can describe the processing path that we would follow to compute and apply more than one correction function. If the correction transforms have already been calculated and saved, this is the preferred order in which the transforms should be applied. Also, if more than one transform is being calculated, this is the preferred order in which to calculate the transforms. On FIG. 7A, if the user is processing distributed images, the first decision, step S500, “Compute new input to output mapping function?” will be answered “No.” and the processing will drop to step S620 in FIG. 7B, “Apply stored input to output signal mapping function to produce output signal.” However, if the user to compute one or more new transforms, the answer to the question in step S500 will be “Yes.” In this case the input signal has to be the input signal for the computation of the transform that needs to be computed. The input Y′P′_{B}P′_{R} signals must be converted to the intended XYZt tristimulus values, step S510. These tristimulus values must either be used to calculate a surround transform, step S530, or be corrected for the surround condition (step S540) as described above to give XYZsc. These tristimulus values at step S550, can be used to compute (step S560) a new ambient correction function. At step S570 the ambient correction function is applied to these tristimulus values. These are the tristimulus values the display device must produce based on the ambient light, XYZa as described above. At this point, the user has the option of computing a new primary color matrix, the gamma correction function(s), and/or the white point mapping function, step S580. If the user chooses to compute any of these functions, they are computed in step S590. Next these tristimulus values must be converted (step S600) to display RGB values using the XYZ to RGB matrix calculated above based on the actual primaries and white point in the device. Next the RGB values must be corrected for the actual gamma of the display device (also step S600) as described above. If any RGB values are greater than the relative 1 signal or less than 0, they must be clipped to 1 or 0 respectively. And finally, the corrected RGB values can be converted (step S600) to Y′P′_{B}P′_{R} signals that will be sent to the display device. Finally, step S610, all of the input-output mapping functions can be combined into one input-output mapping function. This combination can be a simple sequence of individual mapping functions performed in the order described or they can be combined into a smaller number of mapping functions to simplify the calculations as is known by one skilled in the art.

One further improvement in the system would be to include a gamut mapping function that would correct the RGB values that are greater than 1 or less than 0 in a manner that produces a better image than the simple clipping operation produces. There are a number of gamut mapping algorithms that could be applied.

### System Configurations

Based on the foregoing description, it should be apparent that there are a number of embodiments of calibration systems that can be configured according to the invention, as follows:

1) System consisting of

A calibration unit connected between the content delivery device (e.g., DVD player, set-top box, TV cable) and the display device (e.g., TV, Projector)

A remote control unit for interactions and data communication with the calibration unit.

A color sensor integrated in a remote control unit or a separate color sensor that can be connected to a remote control when needed (like digital camera for handheld devices)

2) System consisting of

The display device with integrated calibration system

A display device remote control with a color sensor (integrated or pluggable) and enhance data communication for interaction with the calibration unit

3) System consisting of

The content delivery device with integrated calibration system

A content delivery device remote control with a color sensor (integrated or pluggable) and enhanced data communication for interaction with calibration unit

4) System consisting of

The display device with integrated calibration system and color sensor

A display device remote control and enhanced data communication for interaction with display device

The following system configurations have light sensors instead of color sensors. These system will NOT allow primary color corrections:

5) System consisting of

A calibration unit connected between the content delivery device (e.g., DVD player, set-top box, TV cable) and the display device (e.g., TV, Projector)

A remote control unit for interactions and data communication with the calibration unit.

A light sensor integrated in a remote control unit or a separate light sensor that can be connected to a remote control when needed

6) System consisting of

The display device with integrated calibration system

A display device remote control with a light sensor (integrated or pluggable) and enhanced data communication for interaction with the calibration nit

7) System consisting of

The content delivery device with integrated calibration system

A content delivery device remote control with a light sensor (integrated or pluggable) and enhanced data communication for interaction with calibration unit

8) System consisting of

The display device with integrated calibration system and a light sensor

A display device remote control and enhanced data communication for interaction with display device

### System Operation

With reference to system operation as shown in FIG. 7, the operation of the calibration system can be summarized in outline form as follows:

1. User initiates display calibration process using the remote control unit

a. A key on the remote control keypad that displays the calibration menu.

b. Using menu display by pressing the menu button on the remote control keypad and then selecting the calibration option from the menu.

2. A menu with calibration options is displayed. Some of the possible menu options are:

a. Device (gamma) calibration

b. Primary Color Adjustment

c. White Point Balance Adjustment

d. Surround effect correction

e. Any combinations

Note that since ambient light is common in most environments, ambient effect correction will be needed for all the above options if the system is to achieve an optimal quality level.

3. User selects an option. Note that an alternate implementation can be to have keys on remote control keypad for these options.

4. Ambient effect correction

a. Calibration unit displays a zero signal on the display device. User instructions to properly capture the displayed zero signal can be optionally displayed on the display device.

b. User follows the instruction to capture the displayed signal using the sensor and remote unit.

c. The captured signal is communicated to the calibration unit.

d. The ambient effect correction process (FIG. 2) is applied.

5. Device calibration

a. Calibration unit displays a color pattern on the display device. User instructions to properly capture the displayed color pattern can be optionally displayed on the display device.

b. User follows the instruction to capture the displayed color pattern using the sensor and remote unit.

c. The captured color pattern is communicated to the calibration unit.

d. If no ambient effect correction is needed, the device (gamma) correction process (FIG. 4) is applied.

e. If ambient effect correction is needed, the process for device (gamma) correction in presence of ambient light (FIG. 6) is applied.

f. The calibration unit displays a message on the display device signaling the end of the process.

6. Primary Color Correction

a. Calibration unit displays a color pattern on the display device. User instructions to properly capture the displayed color pattern can be optionally displayed on the display device.

b. User follows the instruction to capture the displayed color pattern using the sensor and remote unit.

c. The captured color pattern is communicated to the calibration unit.

d. If no ambient effect correction is needed, the device primary color correction process (FIG. 4) is applied.

e. If ambient effect correction is needed, the process for device primary correction in presence of ambient light (FIG. 6) is applied.

f. The calibration unit displays a message on the display device signaling the end of the process.

7. White point balance adjustment

a. Calibration unit displays white color on the display device. User instructions to properly capture the displayed white signal can be optionally displayed on the display device.

b. User follows the instruction to capture the displayed signal using the sensor and remote unit.

c. The captured signal is communicated to the calibration unit.

d. The white point balance adjustment process (FIG. 5) is applied.

e. The calibration unit displays a message on the display device signaling the end of the process.

8. Surround effect correction—To be performed whenever the display device is used in a new location

a. User instructions to capture surround data can be optionally displayed on the display device.

b. User follows the instruction to capture the surround data from one or more locations using the sensor and the remote control.

c. The captured data from every location is communicated to the calibration unit.

d. The surround effect correction process is applied.

e. The calibration unit displays a message on the display device signaling the end of the process.

9. Apply input signal correction process (FIG. 7) to produce the output signal for display.

In summary, this disclosure describes a color calibration system for display devices like TVs or projectors to provide the best viewing experience for the incoming video content stream under any viewing condition. As set forth hereinbefore, this color calibration system primarily will comprise the following functional units:

a. Display unit sensors—This functional unit (sensor unit 16) will be used to periodically collect the color characteristics (e.g., hue, brightness, saturation, contract settings) of the display unit like TV or projector.

b. Viewing condition sensor—This functional unit (sensor unit 16) will be used to capture the viewing conditions (e.g., ambient light, glare, etc. on a TV monitor) and their impact on the display of the input video contents on the display unit.

c. Video input stream sensor—This functional unit (calibration unit 12) will be used to collect color characteristics of the input content stream.

d. Color mapping computation unit—This functional unit (color management processor 14) will utilize the data collected on the characteristics of the display unit, the viewing condition, and the input video stream to generate a color mapping function to transform the color characteristics of the input stream to yield the best possible display of the contents.

e. Content color transformation unit—This unit (color management processor 14) will apply the color mapping function generated by the color mapping computation unit to transform the input video/imagery data and send the transformed signals to the display unit.

In one of the present embodiments, all these functional units will reside in two physical devices. The display unit sensor, video input stream sensor, color mapping computation unit, and the content color transformation unit will all be in a single physical device (IC chip, board, or a set-top box like unit), called the calibration unit 12. This unit will be connected between the source of input content (e.g., DVD player 26, video game box 24, computer 28, cable connection 30, etc.) and the display unit 10 (e.g., TV monitor, or projector output unit). This unit 12 will be either integrated as a component into a TV or projector unit or a separate set-top box like small unit. The viewing condition sensor will be resident in a remote control 16. This remote control device (a separate unit or a component of the conventional TV/Universal remote control) when operated by a user from the viewing location will collect the characteristic of viewing environment and its impact on the display unit and send it to the calibration unit. The calibration unit 12 will perform all the data analysis, computation of the mapping function, and color transformations and will send the transformed content stream to the display unit 10.

According to the foregoing concepts, the intent is to provide two types of units—one that can be integrated into the display unit or consumer electronic devices in the future production and the other than can be used with the traditional (existing) TV, projectors, and display devices. Other implementations of this concept are possible.

Simple variants of this basic concept can be implemented for the calibration of (i) computer monitors for viewing digital images/videos, (ii) business projectors for displaying images and PowerPoint/multimedia presentations, (iii) laser light display/projection systems, and (iii) image printers

The invention has been described with reference to a preferred embodiment. However, it will be appreciated that variations and modifications can be effected by a person of ordinary skill in the art without departing from the scope of the invention.

### Parts List

10 content display unit

12 calibration unit

14 color management processor

16 sensor unit

18 predetermined colors

20a ambient light

20b surround light

22 memory section

24 video game

26 DVD/VCR player

28 computer

30 satellite/cable connection

32 network connection

What is claimed is:

1. A method for evaluating colorimetry of viewing conditions affecting a viewer and calibrating a display device used by the viewer relative to an environment surrounding the display device, said method comprising the steps of:
(a) measuring the colorimetry of predetermined display colors produced by the display device and generating display colorimetry data;
(b) measuring the colorimetry of the viewing conditions and generating viewing condition colorimetry data, wherein the viewing conditions include the effect of surround light originating from the environment surrounding the display device and impinging upon the viewer rather than the display device;
(c) calculating a color conversion function from the display colorimetry data and the viewing condition colorimetry data, said color conversion function being capable of transforming an input video signal into a transformed video signal that shows an improved image based on the colorimetry of the display device and the colorimetry of the viewing conditions;
(d) using the color conversion function to perform color conversion of the input video signal, thereby generating a transformed video signal; and
(e) displaying the transformed video signal on the display device.

2. The method as claimed in claim 1 wherein the viewing conditions in step (b) further include the effect of ambient light originating from the environment surrounding the display device that reflects off a faceplate or screen of the display device and impinges upon the viewer.

3. The method as claimed in claim 1 wherein the viewer is a home viewer and the surrounding environment is that of a home entertainment system.

4. The method as claimed in claim 1 wherein step (a) measures the colorimetry of a white point of the display device and the color conversion function calculated in step (c) includes a white point correction.

5. The method as claimed in claim 1 wherein step (a) measures the colorimetry of a luminance characteristic of the display device and the color conversion function calculated in step (c) includes a gamma correction.

6. The method as claimed in claim 1 wherein the predetermined display colors are a set of primary colors and step (a) measures the colorimetry of the primary colors of the display device and the color conversion function calculated in step (c) includes a primary color correction.

7. A method for evaluating colorimetry of viewing conditions affecting a viewer and calibrating a display device used by the viewer relative to an environment surrounding the display device, said method comprising the steps of:
(a) measuring the colorimetry of the viewing conditions and generating viewing condition colorimetry data, wherein the viewing conditions include the effect of surround light originating from the environment surrounding the display device and impinging upon the viewer rather than the display device;
(b) calculating a color conversion function from the viewing condition colorimetry data, said color conversion function being capable of transforming an input video signal into a transformed video signal that shows an improved image based on the colorimetry of the viewing conditions;
(c) using the color conversion function to perform color conversion of the input video signal, thereby generating a transformed video signal; and
(d) displaying the transformed video signal on the display device.

8. The method as claimed in claim 7 wherein the viewing conditions in step (a) further include the effect of ambient light originating from the environment surrounding the display device that reflects off a faceplate or screen of the display device and impinges upon the viewer.

9. A system for evaluating colorimetry of viewing conditions affecting a viewer and calibrating a display used by the viewer relative to an environment surrounding the display, said system comprising:
a display unit having a screen;
a sensing stage for measuring (a) the colorimetry of predetermined display colors produced by the display unit and generating display colorimetry data, and (b) measuring the colorimetry of the viewing conditions and generating viewing condition colorimetry data, wherein the viewing conditions include the effect of surround light originating from the environment surrounding the display unit and impinging upon the viewer rather than the screen of the display unit; and
a calibration stage for (a) calculating a color conversion function from the display colorimetry data and the viewing condition colorimetry data, said color conversion function being capable of transforming an input video signal into a transformed video signal that represents an improved image based on the colorimetry of the display unit and the colorimetry of the viewing conditions, and (b) using the color conversion function to perform color conversion of the input video signal, thereby generating a transformed video signal that is displayed on the display unit.

10. The system as claimed in claim 9 wherein the sensing stage includes a remote unit for at least measuring the colorimetry of the predetermined viewing conditions and generating viewing condition colorimetry data.

11. The system as claimed in claim 9 wherein the calibration stage is incorporated into the display unit.

12. The system as claimed in claim 9 wherein the calibration stage is a unit separate from, and connected to, the display unit.

13. The system as claimed in claim 9 wherein the viewing conditions include the effect of ambient light originating from the environment surrounding the display unit that reflects off the screen of the display unit and impinges upon the viewer.

14. A system as claimed in claim 9 wherein the viewer is a home viewer and the surrounding environment is that of a home entertainment system.

15. A system for evaluating colorimetry of viewing conditions affecting a viewer and calibrating a display used by the viewer relative to an environment surrounding the display, said system comprising:
a display unit having a screen;
a sensing stage for measuring the colorimetry of the viewing conditions and generating viewing condition colorimetry data, wherein the viewing conditions include the effect of surround light originating from the environment surrounding the display unit and impinging upon the viewer rather than the screen of the display unit; and
a calibration stage for (a) calculating a color conversion function from the viewing condition colorimetry data, said color conversion function being capable of transforming an input video signal into a transformed video signal that represents an improved image based on the colorimetry of the viewing conditions, and (b) using the color conversion function to perform color conversion of the input video signal, thereby generating a transformed video signal that is displayed on the display unit.

16. The system as claimed in claim 15 wherein the viewing conditions further include the effect of ambient light originating from the environment surrounding the display unit that reflects off the screen of the display unit and impinges upon the viewer.

17. Calibration apparatus for evaluating colorimetry of viewing conditions affecting a viewer and calibrating an input video signal applied to a display used by the viewer relative to an environment surrounding the display, said apparatus comprising:
a sensing stage for measuring the colorimetry of the viewing conditions and generating viewing condition colorimetry data, wherein the viewing conditions include the effect of surround light originating from the environment surrounding the display and impinging upon the viewer rather than the display; and
a calibration stage for calculating a color conversion function from the viewing condition colorimetry data, said color conversion function being capable of transforming the input video signal into a transformed video signal that represents an improved image based on the colorimetry of the viewing conditions.

18. The apparatus as claimed in claim 17 wherein the viewing conditions further include the effect of ambient light originating from the environment surrounding the display that reflects off the display and impinges upon the viewer.
